(19) United States
(12) Patent Application Publication
(10) Pub. No.: US 2003/0179245 A1
(43) Pub. Date: Sep. 25, 2003

(54) Medical imaging apparatus, method for transiting display screen in the apparatus, and screen transition program

(75) Inventor: Eiichi Akagi, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 10/386,491

(22) Filed: Mar. 13, 2003

(30) Foreign Application Priority Data
Mar. 20, 2002 (JP) 2002-078615

(51) Int. Cl. G09G 5/00

(52) U.S. Cl. 345/804

(57) ABSTRACT

A medical imaging apparatus for displaying a plurality of screens, including a transition route setting section for setting a transition route among the plurality of the screens in accordance with a workflow set beforehand; and a transition switch designating section for designating at least one switch for transiting to a screen which is a destination of the set route, on each of the plurality of the screens.

### BACKGROUND OF THE INVENTION

1. Field of the Invention

The present invention relates to a medical imaging apparatus, a method for transiting display screens in the apparatus, and a screen transition program. Particularly, the present invention relates to a medical imaging apparatus for inputting information required for photographing, reading and displaying medical image data recorded in a medical image, such as radiographic image or the like, converting medium, a method for transiting display screens in the apparatus, and a screen transition program.

2. Description of Related Art

A radiographic image obtained by using radiation, such as X-ray or the like, has been used widely as a medical image for diagnosing diseases. For example, so-called X-ray photograph by which development is performed by irradiating the X-ray transmitted through a subject to a phosphor layer (phosphor screen) and irradiating the visible light generated in the phosphor layer to a film, in which silver salts are used like usual photograph, has been used in earlier technology.

However, recently, a radiographic image generating method for taking out a radiographic image as a digital signal directly from a radiation detector, such as a stimulating phosphor, an FPD (Flat Panel Detector) or the like, has been used instead of a film coated with silver salts. The radiographic image obtained by the radiographic image generating method is processed variously so as to be more suitable for diagnosis.

Concretely, for example, a radiographic image converting method in which a stimulating phosphor is used and visible rays or infrared rays are used as stimulating excitation lights, is disclosed in the U.S. Pat. No. 3,859,527 and the Japanese Patent Laid-Open Publication No. 55-12144. In this method, a radiographic image converting plate in which a stimulating phosphor layer is formed on a supporting member is used. The radiation transmitted through a subject is irradiated to this stimulating phosphor layer, and a latent image is formed by accumulating the radiation energy corresponding to the quantity of radiation transmitted through each body part of the subject. Thereafter, the stimulating phosphor layer is scanned by a stimulating excitation light, such as laser beam having a predetermined wavelength or the like, and the accumulated radiation energy is emitted as a stimulating light. Then, the stimulating light is converted photoelectrically into electric signals by using a photoelectric transducer, such as photomultiplier or the like, and the electric signals are taken out.

The radiographic image diagnostic system utilizing the stimulating phosphor is commonly referred to as “Computed radiography (CR)”, which can be roughly classified into two types. One is an erect/supine exclusive use type of system that a radiographic image converting plate is incorporated into a reading device. The other is a cassette type of system comprising a portable cassette containing the stimulating phosphor therein and a reading device for reading an image by pulling out a stimulating phosphor from the cassette. The above-described cassette type of radiographic image diagnostic system will be explained with reference to FIG. 14.

As shown in FIG. 14, the cassette type of radiographic image diagnostic system 100 comprises an X-ray photographic room 104 for photographing a subject M, a portable cassette 117 into which a radiographic image converting plate having a stimulating phosphor sheet 124 for accumulating radiation energy is incorporated, a reader 102 for reading a radiographic image from the cassette 117, and a console 103 for controlling the reader 102, displaying an image data and inputting a photographing condition, a reading condition and the like.

In the X-ray photographic room 104, the subject M is positioned between a radiation source 104a and the cassette 117. When the radiation is irradiated from the radiation source 104a, the stimulating phosphor sheet 124 contained in the cassette 117 accumulates a part of irradiated radiation energy. After the photographing, when the cassette 117 is set to the reader 102, the reader 102 irradiates an excitation light to the stimulating phosphor sheet 124 contained in the cassette 117. By the irradiated excitation light, a stimulating light emitted in accordance with the accumulated radiographic image information is photoelectrically converted. After the A/D conversion, a signal is outputted as a digital image data.

The console 103 controls the reading operation of the reader 102 and comprises a monitor for inputting information, such as patient information, a region to be photographed and the like, and for confirming the read image. In the monitor, for example, a reception list screen for displaying information list relating to a registered patient, a search screen for registering a new patient and for inputting a predetermined search condition to search the patient information, a photographing condition selecting screen for setting region-to-be-photographed information for the selected patient, a photographing routine screen for displaying the obtained image and the like are displayed in order. By using the photographing routine screen, the patient is diagnosed. In general, in the photographing routine screen, a display format in which one main image data is largely displayed and the other related obtained image data are displayed smaller in a thumbnail style (one image view format) is adopted.

As users of the above-described radiographic image diagnostic system 100, there are various users, such as hospitals in which many readers 102 and consoles 103 are disposed, clinics in which one set of reader 102 and console 103 is disposed, and the like. In earlier technology, since a system which can input/edit arbitrary the information relating to photographing, such as patient information, photographing conditions and the like, is said to be good, systems are constructed so as to enable free transition among the above-described various screens (reception list screen, search screen, photographing condition selecting screen, and photographing routine screen).

Concretely, for example, it is constructed so as to enable to transit directly from a screen for inputting patient information, such as reception list screen, search screen or the like, to a photographing routine screen. It can transit to the photographing routine screen by inputting only the patient information. Thereafter, it can be operated in a sequence such that region to be photographed and the like are inputted by returning to a photographing condition selecting screen, or even in a sequence such that the photographing routine screen is displayed as an initial screen and patient information, region-to-be-photographed information and the like are inputted by returning to the photographing condition selecting screen, reception list screen or search screen from the photographing routine screen at an arbitrary step.

The above-described construction seems to be convenient on the surface. However, the input procedure becomes uncertain just as free transition is capable, so that it is difficult to realize from which information should be inputted. Therefore, there is a possibility that input leakage occurs. For example, in case of transiting directly from the patient information inputting screen to the photographing routine screen, even though there is input leakage, it is recognized mistakenly that it is in a state capable of photographing since it transits to the photographing routine screen, and it is unaware that photographing conditions are not inputted until just before the photographing. Then, the photographing conditions are inputted just before the photographing, so that inputting error or deterioration in operation efficiency is generated. Further, while inputting just before the photographing in this manner, a patient is made to wait until it becomes in a state capable of photographing. Therefore, there also occurs a problem such that a burden is applied to the patient. Further, when the photographing routine screen is displayed as an initial screen, it is recognized mistakenly that it is in a state capable of photographing even though patient information are not inputted. Thereby, similar inputting error or deterioration in operation efficiency is generated. Moreover, when photographing is carried out without inputting any value, there is a possibility that patients are mixed up since it is unclear that which patient is which. Problems such as input leakage is particularly serious in medical field. Therefore, it becomes an important element among what screens transition is enabled not only in view of improving operationality, but also of performing rapid processing without mistakes.

### SUMMARY OF THE INVENTION

The present invention was made in view of the above-described problems. A main object of the present invention is to provide a medical imaging apparatus capable of preventing easily and certainly input leakage of information relating to photographing, such as patient information, photographing conditions and the like, by making an operator be aware of a workflow, a method for transiting display screens in the apparatus, and a screen transition program.

In order to achieve the above-described object, according to a first aspect of the present invention, the medical imaging apparatus for displaying a plurality of screens, of the present invention, comprises: a transition route setting section for setting a transition route among the plurality of the screens in accordance with a workflow set beforehand; and a transition switch designating section for designating at least one switch for transiting to a screen which is a destination of the set route, on each of the plurality of the screens.

In the present invention, preferably, the apparatus displays at least a patient specifying screen for specifying a patient, a photographing condition selecting screen for selecting a photographing condition corresponding to the patient, and an image data reading screen for displaying image data read from a medical image converting medium in which a medical image of the patient is recorded.

Further, in the present invention, the setting section may include a section for automatically changing a destination to which a screen transits when the same switch is selected, according to presence or absence of at least one of patient information and photographing condition information.

Further, in the present invention, in the setting section, in case there is input leakage in essential patient information, a screen is preferable to be made to transit automatically to a screen for inputting the patient information when an examination start switch, which is a switch designated on one of the plurality of the screens, is selected.

Further, in the present invention, preferably, the setting section includes a section for automatically changing a destination to which a screen transits when the same switch is selected, according to presence or absence of at least one of patient information and photographing condition information, and in the setting section, transition from the patient specifying screen to the photographing condition selecting screen, transition from the photographing condition selecting screen to the image data reading screen, and transition for returning from the image data reading screen to the patient specifying screen are permitted, and in case that the photographing condition information is included in the patient information specified on the patient specifying screen, the patient specifying screen transits directly to the image data reading screen, and in case that the photographing condition information is not included in the patient information, the patient specifying screen transits to the photographing condition selecting screen.

In this case, it is preferable that the patient specifying screen includes a search screen for registering new patient information and searching by using predetermined information as a key, and a reception list screen for displaying a list of the registered patient information; and preferably, transition between the search screen and the reception list screen is mutually permitted, and transition only from the patient specifying screen set as an initial screen to the photographing condition selecting screen or the image data reading screen is permitted.

Further, in the setting section, transition from the patient specifying screen to the photographing condition selecting screen, transition from the photographing condition selecting screen to the image data reading screen, and transition for returning from the image data reading screen to the patient specifying screen may be permitted; and in case that information essential to photographing is inputted, transition from the patient specifying screen to the image data reading screen may be permitted, and in case that the information essential to photographing is not inputted, transition from the patient specifying screen to the image data reading screen may be forbidden.

In this case, it is preferable that the patient specifying screen includes a search screen for registering new patient information and searching by using predetermined information as a key, and a reception list screen for displaying a list of the registered patient information; and preferably, transition between the search screen and the reception list screen is mutually permitted, and transition only from the patient specifying screen set as an initial screen to the photographing condition selecting screen is permitted.

Further, in the present invention, in the designating section, the switch is preferable to be designated with a name capable of recognizing a state of the workflow.

Moreover, in the present invention, the image data reading screen may include a one image view format screen for displaying one image data in a first size and displaying other image data in a size smaller than the first size, and a package image view format screen for displaying a plurality of image data in a second size to be arranged in a line; and transition between the one image view format screen and the package image view format screen may be mutually permitted, and transition from either of the one image view format screen and the package image view format screen to the patient specifying screen set as an initial screen may be permitted.

Further, in the present invention, in the workflow such that specifying the patient, selecting the photographing condition, and photographing the patient are performed separately, a transition switch for designating transition to the patient specifying screen may be provided on the photographing condition selecting screen, and transition from the photographing condition selecting screen to the patient specifying screen set as an initial screen may be performed according to the transition switch. As a transition switch for designating transition to the patient specifying screen in this case is preferable to be a transition switch which designates scheduling operation of the specified patient information and the selected photographing condition information.

Further, in the present invention, a transition switch for designating modifying operation of the specified patient information may be provided on the image data reading screen, and transition from the image data reading screen to the patient specifying screen may be performed according to the transition switch in case that modification of the patient information is required.

Moreover, in the present invention, a transition switch for designating modifying operation of the selected photographing condition may be provided on the image data reading screen, and transition from the image data reading screen to the photographing condition selecting screen may be performed according to the transition switch in case that modification of the photographing condition is required.

Further, in the present invention, in the designating section, the switch provided on each of the screens is preferable to be designated by a different construction (for example, color, shape and the like) or a different name in accordance with a state of the workflow.

Further, according to a second aspect of the present invention, the method for transiting a plurality of display screens utilized for diagnosis, of the present invention, comprises: setting a transition route among the plurality of the screens in accordance with a workflow set beforehand; and designating at least one switch for transiting to a screen which is a destination of the set route, on each of the plurality of the screens.

Moreover, according to a third aspect of the present invention, the method for transiting display screens including a patient specifying screen for specifying a patient, a photographing condition selecting screen for selecting a photographing condition corresponding to the patient, and an image data reading screen for displaying image data read from a medical image converting medium in which a medical image of the patient is recorded, of the present invention, comprises: setting a transition route among the plurality of the screens in accordance with a workflow set beforehand; and designating at least one switch for transiting to a screen which is a destination of the set route, on each of the plurality of the screens with a name capable of recognizing a state of the workflow.

Further, according to a fourth aspect of the present invention, the screen transition program of the present invention is the one for making a computer carry out the above-described method in the second or third aspect.

Thus, in the present invention, with respect to transition among the screen for inputting patient information (reception list screen or search screen), the photographing condition selecting screen for selecting the photographing condition, and the image data reading screen for displaying the image data in which the patient is photographed, a transition route among the screens is set in accordance with the workflow set beforehand, and a transition switch for making it possible to transit to a permitted display screen is designated. Thereby, it is possible to make an operator be aware of the workflow of “select patient”→“start examinations”→“photograph →“complete examinations”, so that rapid processing without input leakage can be realized.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a view showing a construction of a radiographic image diagnostic system;

FIG. 2 is a block diagram showing a construction of a reader and that of a console according to an embodiment of the present invention;

FIGS. 3A and 3B are perspective views showing a structure of a cassette;

FIG. 4 is a view showing a pre-registration type of image reading process;

FIG. 5 is a view showing a post-registration type of image reading process;

FIG. 6 is a view showing an example of a search screen displayed on the console according to the embodiment of the present invention;

FIG. 7 is a view showing an example of a reception list screen displayed on the console according to the embodiment of the present invention;

FIG. 8 is a view showing an example of a photographing condition selecting screen displayed on the console according to the embodiment of the present invention;

FIG. 9 is a view showing an example of an image data reading screen (one image view format) displayed on the console according to the embodiment of the present invention;

FIG. 10 is a view showing an example of an image data reading screen (package image view format (4 views)) displayed on the console according to the embodiment of the present invention;

FIG. 11 is a view showing an example of an image data reading screen (package image view format (2 views)) displayed on the console according to the embodiment of the present invention;

FIGS. 12A and 12B are flowcharts showing a process for the image displaying method (the case that the search screen is an initial screen) according to the embodiment of the present invention;

FIG. 13 is a view showing another example of a search screen displayed on the console according to the embodiment of the present invention; and

FIG. 14 is a schematic view showing an arrangement of a radiographic image diagnostic system in earlier technology.

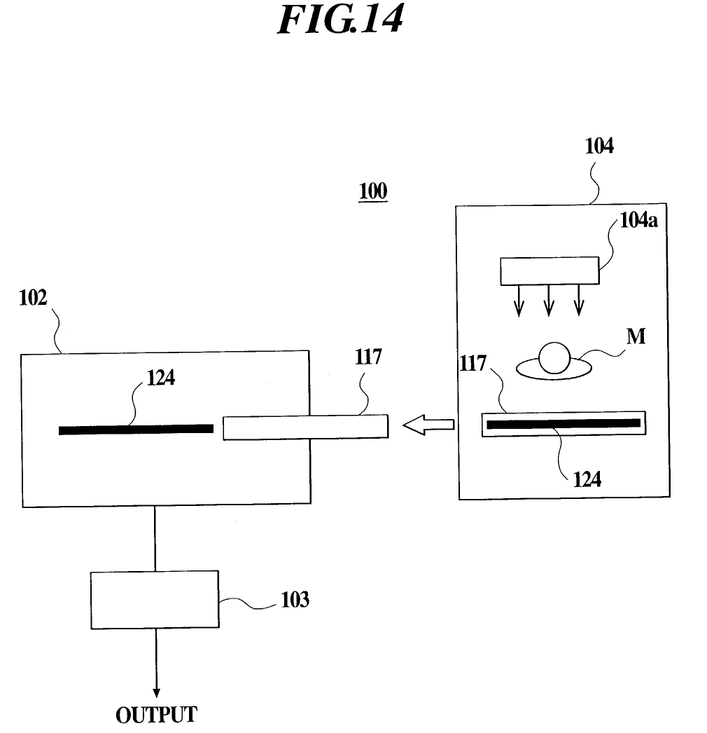

### PREFERRED EMBODIMENT OF THE INVENTION

In a preferred embodiment of the medical imaging apparatus according to the present invention, with respect to transition among a reception list screen or a search screen (patient specifying screen) for inputting patient information, a photographing condition selecting screen for selecting photographing conditions corresponding to the patient information, and a photographing routine screen (image data reading screen) of one image view format or package image view format for displaying image data read from a radiographic image converting medium (medical image converting medium) in which a radiographic image (medical image) of the patient is recorded, the apparatus comprises a section for setting transition routes among the screens in accordance with a workflow set beforehand; and a section for designating transition switches for transiting to a permitted screen on each of a plurality of screens by giving a name capable of recognizing the sequence to the transition switches. By making it possible to transit from only a screen set as an initial screen out of the screens for inputting patient information to the photographing condition selecting screen, forbidding the transition from the screen for inputting patient information to the photographing routine screen, or changing the construction or the name of the transition switches in accordance with the displayed sequence even though it is the same screen, an operator can be made to be aware of the workflow.

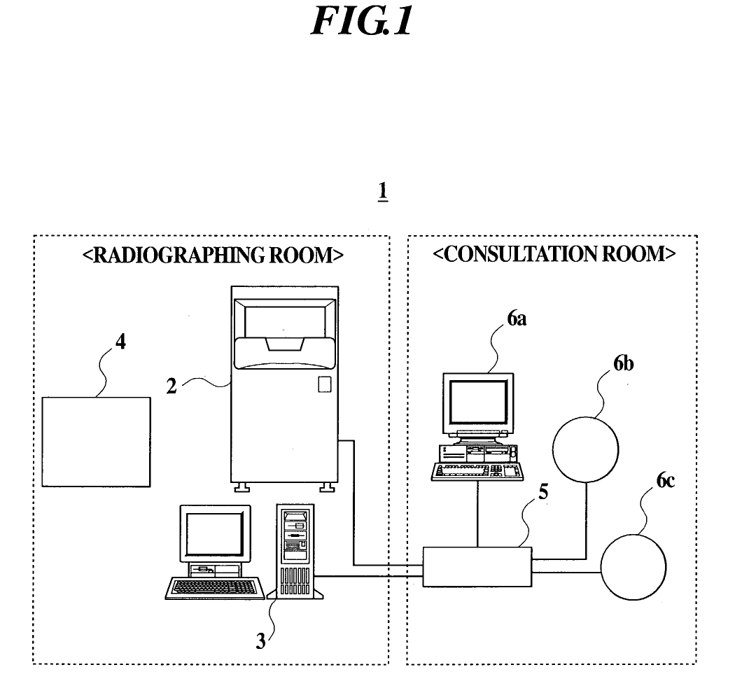

In order to explain the above-described present invention in detail, the image reading apparatus (medical imaging apparatus), the method for transiting display screens in the apparatus, and screen transition program according to the embodiment of the present invention will be explained with reference to FIGS. 1 to 13.

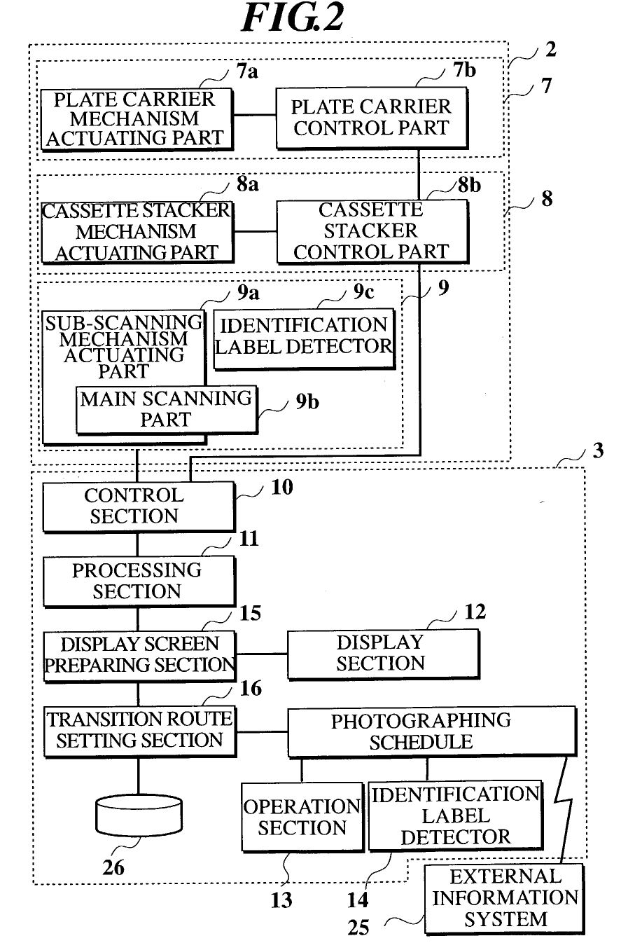

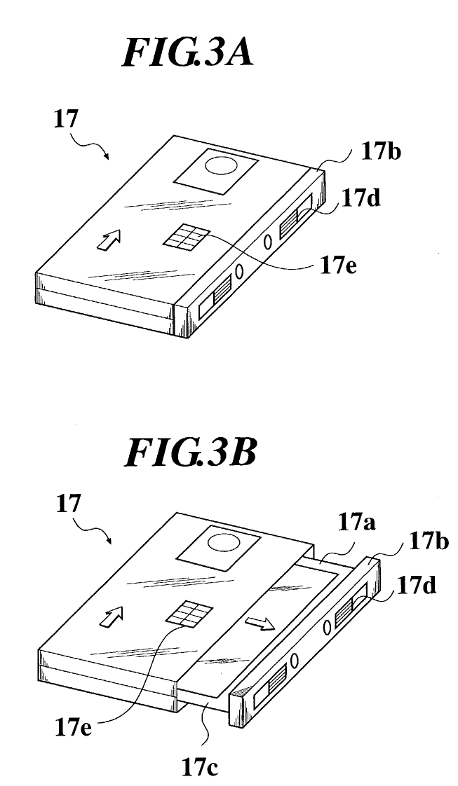

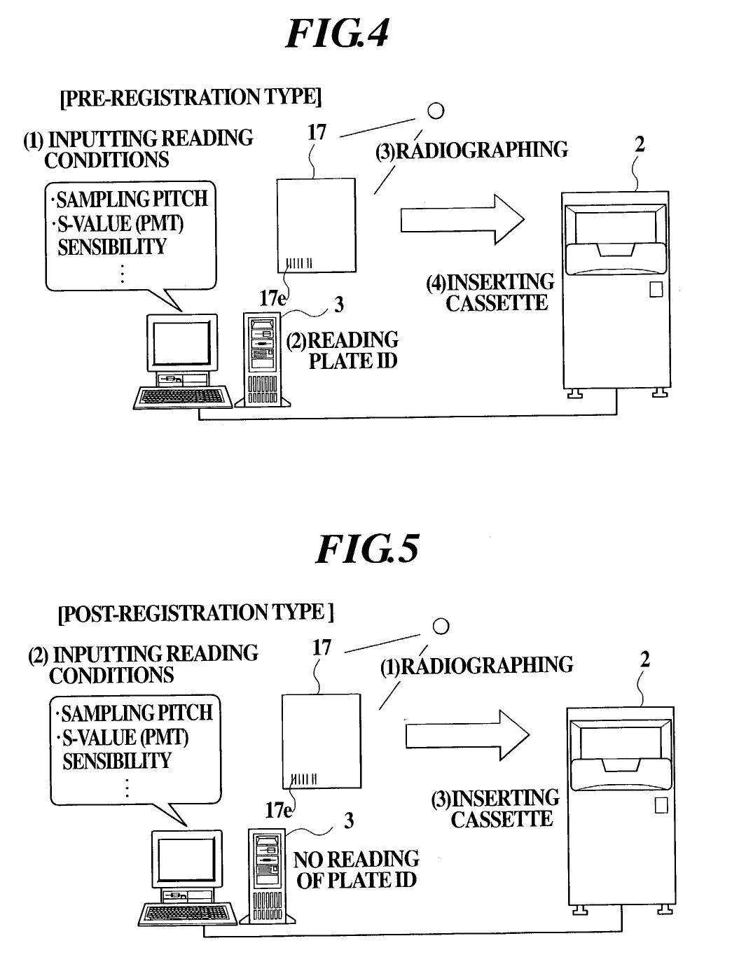

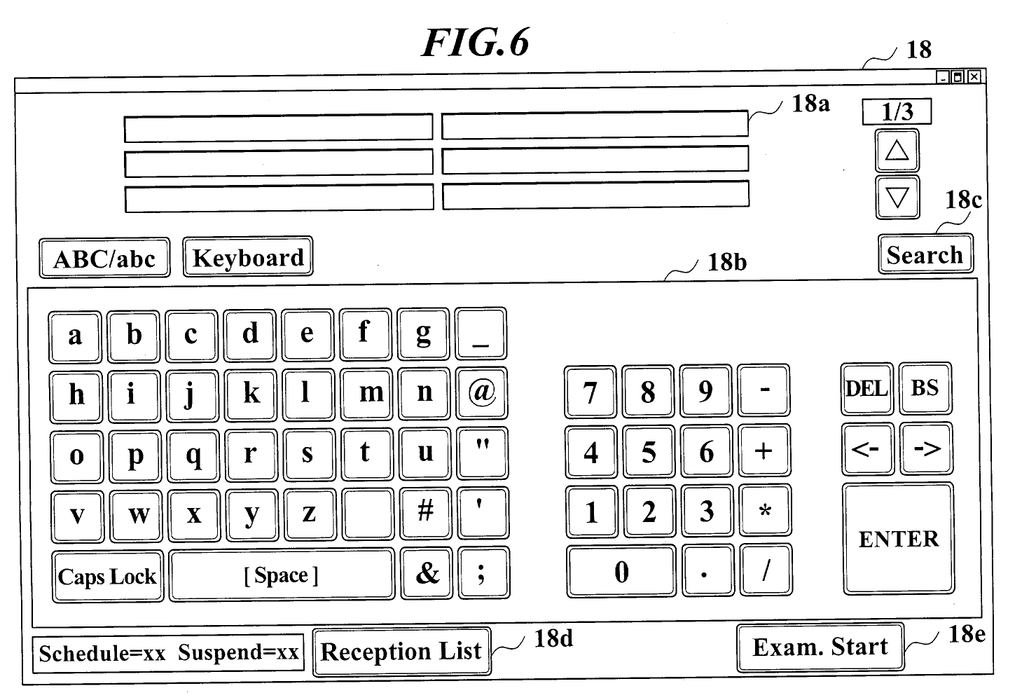

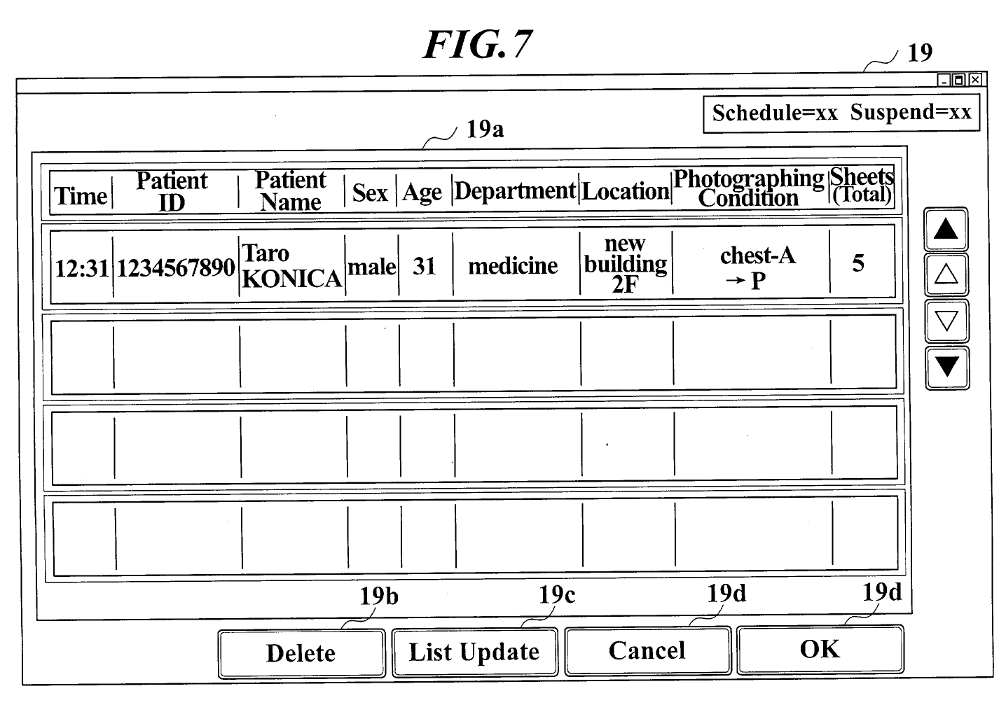

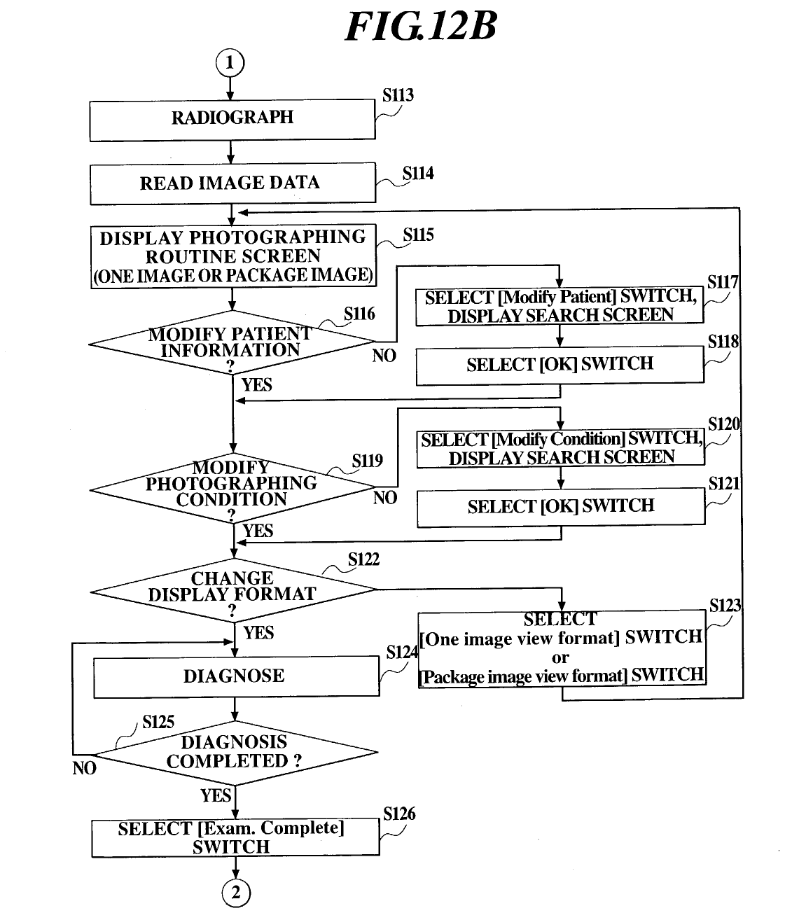

FIG. 1 is a view showing a construction of the radiographic image diagnostic system for realizing the transition method among display screens of the present invention. FIG. 2 is a block diagram showing a construction of the image reading apparatus (a reader and a console). FIGS. 3A and 3B are perspective views showing a structure of the cassette. FIGS. 4 and 5 are views for explaining two registration types of the reading conditions in the image reading process. FIGS. 6 to 11 and 13 are views showing each example of screens displayed on the console constituting the image reading apparatus according to the embodiment. FIGS. 12A and 12B are flowcharts showing a transition process of the display screens of the embodiment.

In the following explanation, an example in which the screen transition method according to the present invention is applied to a cassette type of image reading apparatus, will be described. However, the present invention is not limited to the following example. The present invention can be applied to an arbitral apparatus for displaying a medical image, such as a system using other radiographic image conversion medium, an erect/supine exclusive use type of system in which a radiographic image converting medium is not used, a system for directly fetching the radiographic image as a digital signal by using a radiation detector, such as an FPD or the like, or the like.

In order to easily understand the method for transiting display screens, which is the feature of the present embodiment, firstly, each construction of the radiographic image diagnostic system and the image reading apparatus and each function thereof will be explained.

As shown in FIG. 1, in the radiographic image diagnostic system 1 of the present embodiment, a reader 2 for reading a radiographic image from a cassette in which a latent image is formed according to a device disposed in an X-ray photographic room 4, a console 3 for controlling the reading operation of the reader 2, for displaying the read image and for inputting patient information, region-to-be-photographed information, the reading conditions and the like, are connected through a switching HUB 5 by LAN. In case of necessity, a printer 6c, a viewer 6b, a patient reception terminal 6a and the like are disposed and connected through the switching HUB 5 by LAN. These devices are connected with other medical apparatuses, which are not shown, by a network, such as a DICOM (Digital Imaging and Communications in Medicine) or the like.

In the figure, the reader 2 is separated from the console 3. However, the reader 2 and the console 3 may be incorporated so as to constitute the image reading apparatus. Further, the reader 2 and the console 3 may be disposed in each photographing room. In another case, only the console 3 may be disposed in the photographing room and the reader 2 may be centralized in another place. The disposing position, the arrangement of the connections among the above-described devices, and the like, can be set arbitrary.

Further, in FIG. 1, the patient reception terminal 6a is connected to the switching HUB 5 to input patient information and the like. However, patient information, photographing conditions and the like may be inputted through a network from an information system having a patient information database, such as an HIS (Hospital Information System), an RIS (Radiology Information System) or the like.

The reader 2 for reading the image data obtained by the radiographic image photographing device, for example, as shown in FIG. 5, comprises a cassette stacker section 8 for controlling the insertion of a cassette 17, a plate control section 7 for controlling the carrier of the radiographic image converting plate (medical image converting medium), and an image reading section 9 for reading a latent image by scanning the radiographic image converting plate.

The cassette stacker section 8 comprises a cassette stacker mechanism actuating part 8a and a cassette stacker control part 8b, and a plurality of types of cassettes 17 can be set. In the plate control section 7, a plate carrier mechanism actuating part 7a and a plate carrier control part 7b are provided. The plate carrier control part 7b is controlled in accordance with a command from the cassette stacker control part 8b. The plate carrier mechanism actuating part 7a withdraws the radiographic image converting plate from the cassette 17 to carry it toward the image reading section 9. In the image reading section 9, a sub-scanning mechanism actuating part 9a, a main scanning part 9b and an identification label detector 9c are provided. By the sub-scanning mechanism actuating part 9a, the main scanning part 9b is carried in a sub-scanning direction. By the laser scan of the main scanning part 9b, the image is read. Further, in case that the later-described pre-registration type is adopted, information (plate ID) of the identification label attached to the cassette 17 is read by the identification label detector 9c.

The console 3 for controlling the reading operation of the reader 2, for inputting patient information, region-to-be-photographed information, the reading conditions and the like, and for displaying the read image, comprises a control section 10 for controlling the reader 2 in accordance with the set reading conditions; a processing section 11 for carrying out various image processing (correction processing, contrast transformation processing, trimming, reverse/rotation, changing of each parameter, masking or the like) for the image read by the reader 2; a display screen preparing section 15 for preparing each screen, such as the reception list screen, search screen, photographing condition selecting screen, photographing routine screen and the like; a transition route setting section 16 for setting a transition route among the screens; a display section 12 for displaying the screens; an operation section 13 for setting patient information, region-to-be-photographed information, reading conditions and the like; an identification label detector 14 for reading a plate ID of the cassette 17 in case that the later-described pre-registration type is adopted; and a database 26 for storing photographing history information. The console 3 is connected to an external information system 25, such as a patient reception terminal 6a, HIS, RIS or the like.

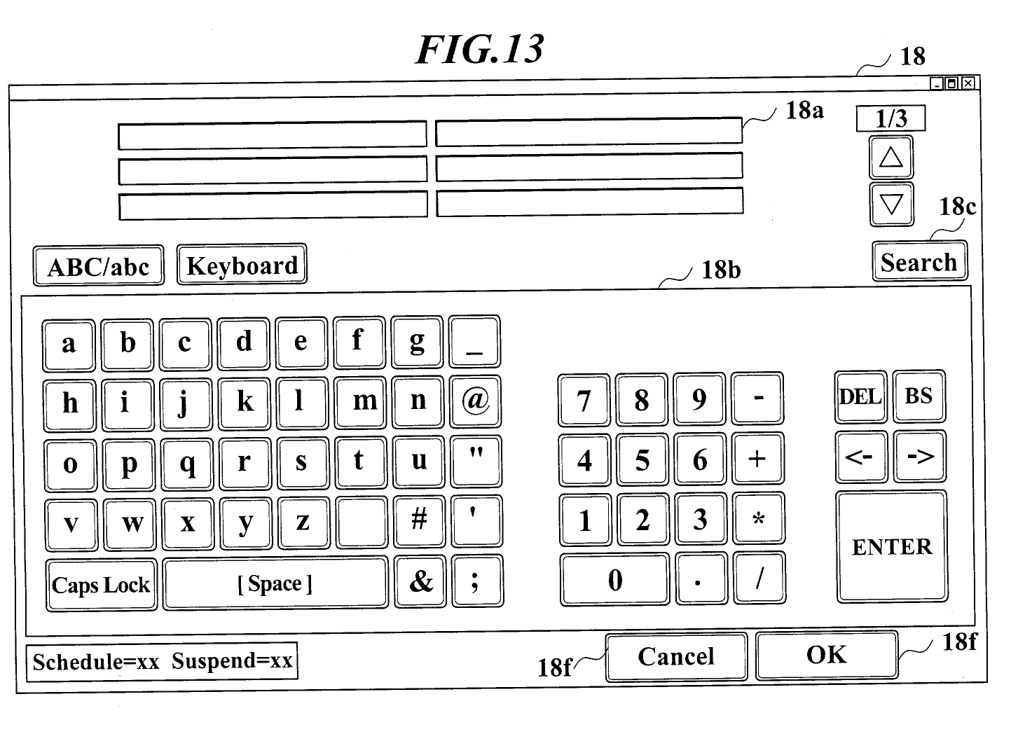

With respect to the reader 2 and console 3, besides the construction such that the control section of the reader 2 is in the console 3 (FIG. 13), it may be a construction such that the control section 10 is included in the reader 2, or a construction such that the processing section 11 is included in the reader 2. Moreover, it may be a construction such that the reader 2 and the console 3 are incorporated.

With respect to the display screens displayed on the display section 12, as described later, the transition route among the screens is set in accordance with the workflow set beforehand, according to the transition route setting section 16. Transition switches for making it possible to transit to a permitted screen are designated on each display screen with a name capable of recognizing the sequence of the workflow. Thereby, an operator is made to be aware of the workflow, that is, the operator can recognize on the screen to what extent the input is proceeding, so that input leakage is prevented from occurring.

In the above-described cassette type of radiographic image diagnostic system 1, in order to specify the correlation between the cassette 17 and the patient information (schedule information), either a process (pre-registration) for carrying out the photographing after the correlation between the cassette 17 and the patient information is registered, or a process (post-registration) for correlating the inserting order of the cassette with the inputting order of the patient information without registering the cassette 17 before the radiographing, is adopted. Then, the image data is read.

In case of the pre-registration type, as shown in FIG. 4, firstly, an operator, such as a radiologist or the like, inputs the reading conditions (sampling pitch, reading sensibility such as S value (PMT) sensibility or the like, or the like) for reading the image with the reader 2, by using the display section 12 and operation section 13 of the console 3 (as shown in (1) of FIG. 4). Then, the information (hereinafter, referred to as “plate ID”) of the identification label 17e (c.f. FIGS. 3A and 3B) attached to the cassette 17 is read by the identification label detector 14 of the console 3 (as shown in (2) of FIG. 4). The inputted reading conditions are correlated with the plate ID. The reading conditions and the plate ID are stored. Thereafter, the radiographing is carried out by using the registered cassette 17 (as shown in (3) of FIG. 4). The cassette 17 in which a latent image is formed is inserted into the reader 2 (as shown in (4) of FIG. 4). In the reader 2, the plate ID of the cassette 17 is read by the incorporated identification label detector 9c. The reading conditions correlating with the plate ID is searched and obtained. The image is read in the above reading conditions.

In case of the post-registration type, as shown in FIG. 5, firstly, an operator, such as a radiologist or the like, carries out the radiographing (as shown in (1) of FIG. 5). Thereafter, the operator inputs the reading conditions for reading the image with the reader 2, by using the display section 12 and operation section 13 of the console 3 (as shown in (2) of FIG. 5). In case of the post-registration type, since the plate ID is not correlated with the reading conditions, it is not necessary to read the plate ID. Then, the cassette 17 in which a latent image is formed is inserted into the reader 2 (as shown in (3) of FIG. 5). In the console 3, the inputting order of the reading conditions is assigned to the inserting order of the cassette in sequence. The reading conditions correlating to the inserted cassette 17 is determined. The image is read in the determined reading conditions.

The pre-registration and the post-registration have each feature. For example, in a hospital or the like, in which many readers 2 and consoles 3 are disposed in each different place and many radiologists carry out the photographing, it is possible to suitably carry out the radiographic image diagnosis for many patients by the pre-registration. On the other hand, in case that a clinic or the like, in which a small number of readers 2 and a small number of consoles 3 are disposed and a small number of radiologists carry out the radiographic image diagnosis, it is possible to carry out the radiographing rapidly and effectively by the post-registration. The method for transiting display screens, which is the feature of the present invention, can be applied to the both registration types.

The examination process in case that the search screen is displayed as an initial screen, which is carried by using the radiographic image diagnostic system 1 having the above-described construction, will be explained with reference to each example of the screens shown in FIGS. 6 to 11 and 13 and the flowcharts shown in FIGS. 12A and 12B. The following explanation is described about the process in which the image data is read by the pre-registration. However, even in the post-registration, the operation of transition among the display screens is the same as the operation carried out in the pre-registration.

Firstly, in Step S101 in FIG. 12A, patient information is inputted by the display section 12 and operation section 13 of the console 3. Here, the case that the search screen 18 shown in FIG. 6 is set as a default value will be explained. The search screen 18 is provided with a display area 18a for displaying search results; an input area 18b for displaying a keyboard for inputting characters; a search button 18c for indicating to carry out the search; and in addition, transition switches (a “Reception List” transition switch 18d for transiting to the reception list screen 19 and an “Exam. Start” transition switch 18e for transiting to the photographing condition selecting screen 20) for making it possible to transit to a specific screen by making an operator be aware of the workflow, which are the feature of the embodiment.

Then, an operator such as a radiologist or the like enters a predetermined search key by operating the keyboard on the input area 18b, and selects a “Search” button 18c (hereinafter, an operation of touching a screen or clicking it with a mouse will be referred as “selecting”). The patient information is searched with reference to the external information system 25, such as the patient reception terminal 6a, HIS, RIS or the like, the database 26 or the like, and displayed on the display area 18a.

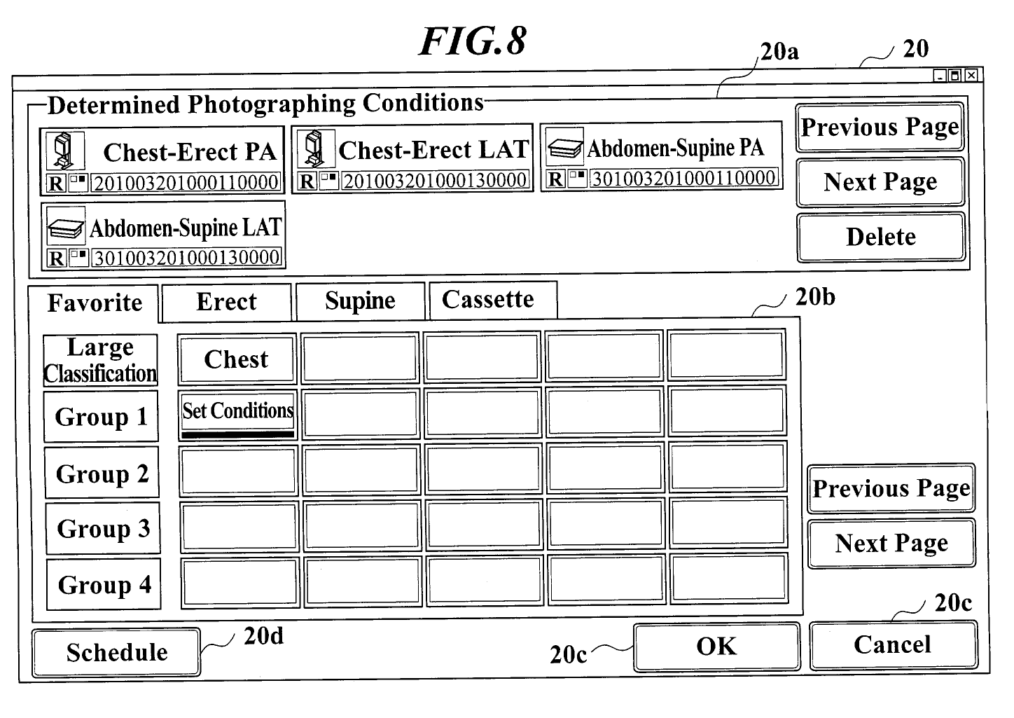

The patient information can be obtained from the reception list screen 19 (Step S102). In this case, the search screen 18 transits to the reception list screen 19. In the embodiment, in order to make the transition operation clear, the “Reception List” transition switch 18d is provided on the search screen 18, and when the “Reception List” transition switch 18d is selected in Step S103, the reception list screen 19 as shown in FIG. 7 will be displayed in Step S104.

The reception list screen 19 is provided with a display area 19a for displaying the patient information such as a patient ID, a patient name, a sex, an age, a department, a location,sa photographing condition, sheets of images to be photographed, or the like as a list; a “Delete” button 19b for deleting the selected patient information; a “List Update” button 19c for carrying out an update of the list by inquiring to the external information system 25 or the database 26; and transition switches (an “OK” and “Cancel” transition switches 19d to return to the search screen 18) which enables to transmit to a specific screen by making an operator be aware of the workflow, which are the feature of the embodiment.

Then, when the selection of a predetermined patient to be photographed from the displayed list is completed in Step S105, the “OK” transition switch 19d on the reception list screen 19 is selected in Step S106. Then, the reception list screen 19 returns back to the search screen 18 (initial screen) automatically. Thereby, a problem such that photographing is carried out while the input of the patient information has been inadequate can be prevented from occurring. Further, the transition switch for transiting from the search screen 18 to the reception list screen 19 is designated as “Reception List”, and the transition switches for transiting from the reception list screen 19 to the search screen 18 are designated as “OK” and “Cancel”, so that the operator is made to be aware that the main screen for inputting patient information is the search screen 18.

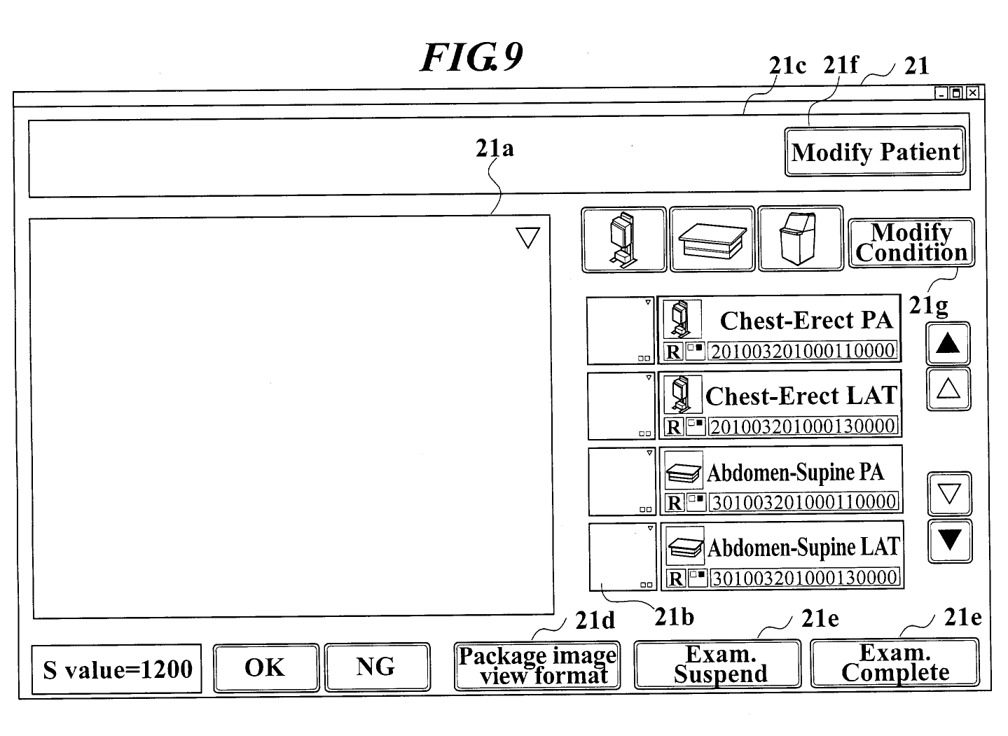

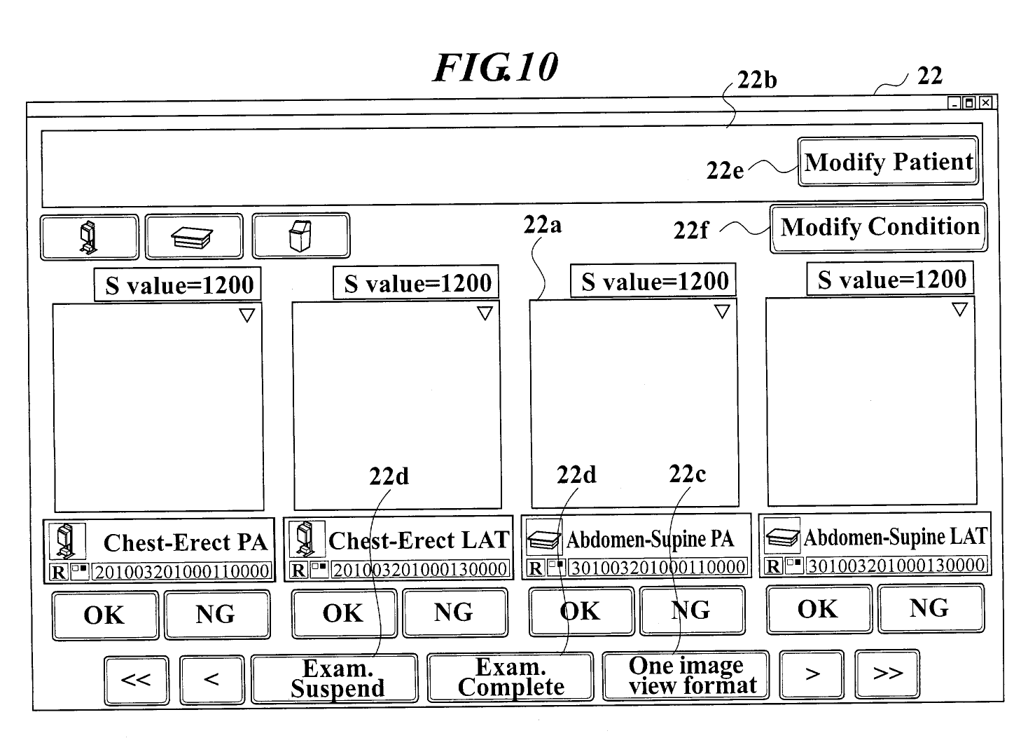

Then, after the operator has confirmed the input of the patient information, in Step S107, the “Exam. Start” transition switch 18e provided on the search screen 18 is selected to transit to a photographing routine mode. In here, the operator is also made to be aware of the workflow by naming the transition switch as “Exam. Start”. In the photographing routine mode, in Step S108, it is judged whether the photographing conditions corresponding to the selected patient are inputted or not. When inputted, one of the photographing routine screens 21 to 23 showing that it is in a state capable of photographing as shown in FIGS. 9 to 11 is displayed, and it proceeds to Step S112. When not inputted, the photographing condition selecting screen 20 as shown in FIG. 8 is displayed in Step S109 to make the operator input the photographing conditions before proceeding to Step S112. According to the screen transition, the operator is made to be aware of the workflow necessary to photograph, so that no leakage of inputted information occurs.

Both patient information and photographing conditions may be inputted with a terminal or the like by an operator, or both of them or only the patient information may be inputted through a network from the external information system 25, database 26 or the like. In case of inputting only the patient information, an operator inputs the photographing conditions on the photographing condition selecting screen 20. Thereby, for example, in the daytime or the like that the information system 25 is actuated, the patient information and the photographing conditions are inputted by the information system 25 through the network. On the other hand, in the nighttime or the like that only the patient information database in the information system 25 is actuated, only the patient information is inputted through the network and the photographing conditions are inputted by an operator. Thus, the input method can be suitably changed in accordance with the situation.

The photographing condition selecting screen 20 is provided with transition switches (an “OK” and “Cancel” transition switches 20c for transiting to the photographing routine screen, and a “Schedule” transition switch 20d for scheduling the photographing and returning to the initial screen (search screen 18)) for making it possible to transit to a specific screen by making an operator be aware of the workflow, which are the feature of the embodiment, together with a display area 20a on which the photographing conditions set beforehand are displayed, and a classification display area 20 on which the photographing conditions set by an operator, such as a radiologist or the like, or those classified in every photographing mode is displayed.

Then, the operator selects a condition suitable for photographing a patient from the photographing conditions set beforehand or the classified photographing conditions. In the photographing conditions, information which shows the region to be photographed or information relating to image processing most suitable for the region is included. Furthermore, it may include the reading conditions (sampling pitch, reading sensibility and the like) of the photographed image data, and format of the output. Then, when the selection of the photographing conditions is completed in Step S110, the “OK” transition switch 20c or the “Schedule” transition switch 20d provided on the photographing condition selecting screen 20 is selected. When the “Schedule” transition switch 20d is selected, it returns to the initial screen (search screen 18) by correlating the selected photographing conditions with the patient information and storing them as schedule information. When the “OK” transition switch 20c is selected, one of the photographing routine screens 21 to 23 showing that it is in a state capable of photographing as shown in FIGS. 9 to 11 is displayed, and the identification label information (plate ID) read from the cassette 17 with the identification label detector 14 in the consoled 3 is correlated with the photographing conditions and reading conditions in Step S112. Here, when the correlation of the cassette and the photographing conditions is performed beforehand, Step S112 is skipped. Further, in case of the post-registration type, since this Step S112 may not be carried out, a part of or the whole photographing is carried out by this post-registration type, so that there is a case that Step S112 is not carried out (c.f. an arrow of dotted line in FIG. 12A).

Thus, in the embodiment, the transition route is set so that the photographing routine screens 21 to 23, which show that it is in a state capable of photographing, will not be displayed unless all of the patient information, photographing conditions and the like necessary to photograph are inputted.

Next, in Step S113 in FIG. 12B, a selected patient is photographed with a radiographic image photographing device, such as an X-ray photographic device or the like, by a well-known method, and an X-ray transmission image of the patient is stored in the radiographic image converting plate in the cassette 17 as a latent image. The radiographic image photographing device is not limited to the X-ray photographic device. It includes an arbitrary photographic device which is used in the medical field, such as a device for photographing a patient with a magnet or ultrasonic wave, or the like.

Next, when the operator, such as a radiologist or the like, extracts the cassette 17 from the radiographic image photographing device and inserts the extracted cassette 17 into an arbitral slot of the reader 2, in case of the pre-registration, the plate ID is read by the identification label detector 9c to search the reading conditions in a database by using the plate ID as a search key, and to extract the reading conditions corresponding to the plate ID. In case of the post-registration, after a cassette inserting order cue is correlated with a schedule selecting cue, the reading conditions corresponding to the cassette 17 are extracted. Thereafter, in Step S114, the latent image of the radiographic image converting plate is read by the reader 2 in accordance with the set reading conditions.

In the process for reading the image data, firstly, the sensibility of the image reading section 9 is set in accordance with the value of the reading sensibility. The carrier speed of the plate carrier mechanism actuating part 7a and the sampling pitch of an A/D converter provided in the image reading section 9 are set in accordance with the value of reading resolution. Then, the radiographic image converting plate is withdrawn from the cassette 17. While the radiographic image converting plate is carried in an X-direction by the sub-scanning mechanism actuating part 9a to execute the sub-scanning of the image, the image data accumulated and held in the radiographic image converting plate is read.

Then, when the excitation light acts on the radiographic image converting plate, the energy accumulated in the phosphor is generated as a stimulating light. The stimulating light is concentrated to convert the light into an electric signal by the image reading section 9. The electric signal is transformed logarithmically by a logarithmic transformer (thereby, a linear electric signal which is linear to the light intensity of the stimulating light, is transformed to an electric signal which is logarithmically linear to the light intensity of the stimulating light, that is, an electric signal which is linear to the thickness). Further, the electric signal is converted into a digital one by the A/D converter.

A correction processing peculiar to the image reading section 9 and the radiographic image converting plate (such as the shading correction for the image reading section 9, the unevenness correction for the unevenness caused by the excitation light generating section, and the sensibility unevenness correction for the radiographic image converting plate, and the like), a contrast transformation processing and the like are carried out for the image data outputted from the image reading section 9 by a processing section 11.

Next, in Step S115, the read image data are displayed in accordance with the display format set in default. Here, as shown in FIG. 9, the photographing routine screen 21 of one image view format comprising: a main display area 21a for displaying representative image data; sub display areas 21b for displaying image data photographed in connection with the representative image data and reduced in the thumbnail format; a patient information display area 21c for displaying the inputted patient information; and transition switches (a “Package image view format” transition switch 21d for transiting to the photographing routine screen of a different display format, an “Exam. Suspend” and “Exam. Complete” transition switches 21e for returning to the search screen 18, a “Modify Patient” transition switch 21f for transiting to the search screen 18 in case of modifying the patient information, and a “Modify Condition” transition switch 21g for transiting to the photographing condition selecting screen 19 in case of modifying the photographing conditions) is set as a default.

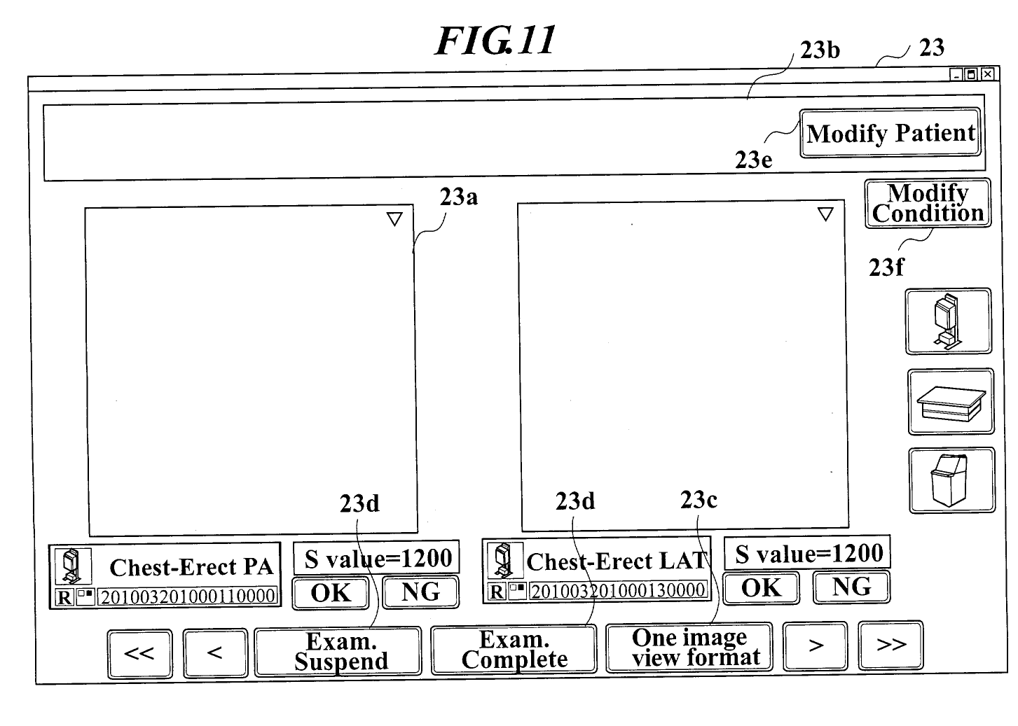

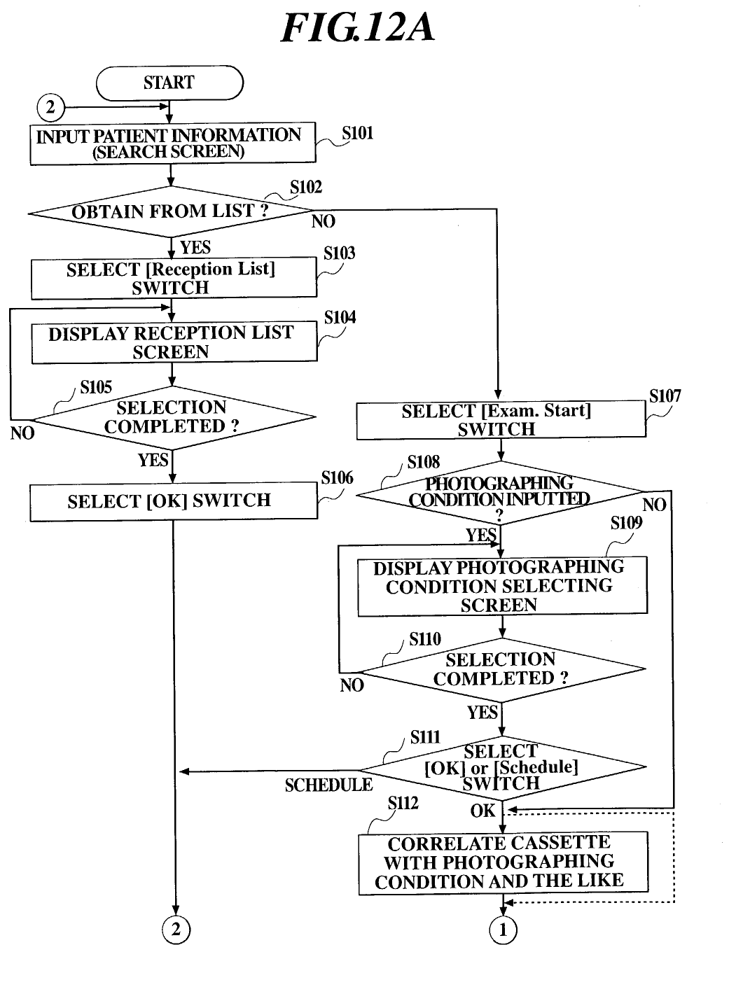

As a display format of image data, besides the one image view format as shown in FIG. 9, it may be a display format (package image view format) such that a plurality of images (four images in the figure) are displayed largely in equal size as shown in FIG. 10, or a display format (package image view format) such that two images are displayed largely in equal size as shown in FIG. 11, or the like. A display format suitable for diagnosis can be selected appropriately.

For example, in case of photographing abdomen, head or other general photographing, the region is photographed independently. It is desirable that each image data is largely displayed. On the other hand, in case of the anteroposterior surface of chest and the lateral surface of chest, two image data are usually obtained and compared in the same size. Further, in case that lumber spine is photographed in four directions (anteroposterior surface, lateral surface, right oblique position and left oblique position), it is necessary to adjust each concentration of the image data obtained in four directions so as to be the same. It is desirable that the four image data can be compared in the same size. Further, in case of eight views display, since the image data are displayed in the same size and arrangement as ones obtained by photographing the patient with a film in a mass survey according to earlier technology, it is possible to use the image data without uncomfortableness. An operator can select a display format and display the image data in accordance with the condition of the patient and the region to be photographed so as to easily carry out the diagnosis.

The display format is not limited to ones shown in the figures. The display format may have various configurations, such as a configuration that an arbitral number of image data are largely displayed to be arranged in a line or a configuration that one large image data, a plurality of middle image data, and a plurality of small image data displayed in a thumbnail style are combined. In particular, the even number of image data are generally obtained in each direction, such as anteroposterior surface+lateral surface, right lateral surface+left lateral surface, right oblique position and left oblique position or the like, to compare one with the others. By displaying the even number of image data, the area of the screen can be effectively used.

Then, after displaying image data in the display format once set as a default, the operator confirms the patient information displayed on the patient information display area 21c, and judges whether to modify the patient information or not in Step S116. In case of modifying the patient information, the “Modify Patient” transition switch 21f on the photographing routine screen 21 is selected in Step S117, and the search screen 18 is displayed. Here also, in order to distinguish the sequence of returning to the search screen 18 since the series of examination is completed from the sequence of modifying the patient information in the middle step of examination, the latter is named as “Modify Patient” to make the operator be aware of the workflow.

Further, in the search screen 18, in order to make the operator be aware of returning to the photographing routine screen 21 by making it clear that it is a mode for modifying the patient information, not a mode for inputting patient information in Step S101, a search screen 18 as shown in FIG. 13 is displayed. On the search screen 18 show in FIG. 13, transition switches (an “OK” and “Cancel” transition switches 18f) for returning to the photographing routine screen 21 of one image view format are displayed instead of the transition switches (the “Reception List” transition switch 18d and the “Exam. Start” transition switch 18e) on the search screen 18 in FIG. 6, to make the operator be aware of the workflow.

Then, in Step S118, after modifying the patient information by using the search screen 18 in FIG. 13, the operator selects the “OK” transition switch 18f to return to the photographing routine screen 21 of one image view format.

Next, the operator confirms the photographing conditions displayed on the photographing routine screen 21, and judges whether to modify the photographing conditions in Step S119. In case of modifying the photographing conditions, the “Modify Condition” transition switch 21g on the photographing routine screen 21 is selected in Step S120, and the photographing condition selecting screen 20 is displayed. Here, it is also named as “Modify Condition” to make it clear that it is modification of the photographing conditions to make the operator be aware of the workflow.

Further, also in the photographing condition selecting screen 20, in order to make the operator be aware of returning to the photographing routine screen 21 by making it clear that it is a mode for modifying photographing conditions, not a mode for inputting photographing conditions in Step S109, a screen different from the photographing condition selecting screen 20 in FIG. 8 is displayed. Concretely, on the photographing condition selecting screen 20 displayed in this step, the “Schedule” transition switch 20d shown in FIG. 8 is not displayed, but only transition switches (an “OK” and “Cancel” switches 20c) for returning to the photographing routine screen 21 of one image view format are displayed to make the operator be aware of the workflow.

Then, in Step S121, after modifying the photographing conditions, the operator selects the “OK” transition switch 20c on the photographing condition selecting screen 20 to return to the photographing routine screen 21 of one image view format.

Thereafter, in Step S122, the operator judges whether to change the display format or not. In case of changing the display format, the “Package image view format” transition switch 21c on the photographing routine screen 21 is selected in Step S123, and the photographing routine screen 22 or 23 of package image view format is displayed. Here, modification of the patient information or modification of the photographing conditions as described above can be carried out with the “Modify Patient” transition switch 22e or 23e or the “Modify Condition” transition switch 22f or 23f. Then, when changing the display format again, the operator selects the “One image view format” transition switch 22c or 23c on the package image view screen 22 or 23 to switch the display sequentially.

Then, the above-described steps are repeated until the image data are displayed in a format suitable for diagnosis. Thereafter, diagnosis of the patient is performed in Step S124. Then, when the diagnosis is completed in Step S125, the “Exam. Suspend” or “Exam. Complete” transition switch 21e provided on the photographing routine screen 21 of one image view format, or “Exam. Suspend” or “Exam. Complete” transition switches 22d and 23d provided on the photographing routine screens 22 and 23 of package image view format, respectively is selected in Step S126, so that it transits to the search screen 18 of Step S101 automatically and processing of the next patient is carried out. Here, the operator is also made to be aware that the series of examination will be completed by naming the transition switch as “Exam. Complete”, and the like.

Here, the difference between the “Exam. Suspend” and “Exam. Complete” transition switches is that when the “Exam. Suspend” transition switch is selected, the patient information, photographing conditions and the like are not deleted but it is designated that the examination is suspended in the place of the corresponding patient on the reception list screen 19, and on the other hand, when the “Exam. Complete” transition switch is selected, the corresponding patient information, photographing conditions and the like are deleted from the reception list screen 19.

Although it is not shown in the figure, on the photographing routine screens 21 to 23 of one image view format or package image view format, when the display area of image data is touched or clicked, the image detail screen may be displayed, so that it can be transit to a screen capable of setting conditions, such as reading conditions, image processing conditions and the like. In this case, transition switches may be provided on the image detail screen to return to the original photographing routine screen when a transition switch is selected. Further, a switch for transiting to a maintenance utility screen capable of confirming and setting the state of the system, utility and the like can be provided on the search screen 18.

Further, in the embodiment, the case that the search screen 18 is displayed as an initial screen is explained. However, the reception list screen 19 may be displayed as an initial screen. In this case, an “Exam. Start” transition switch is displayed on the reception list screen 19 instead of the “OK” and “Cancel” transition switches 19d, and transition switches (an “OK” and “Cancel” transition switches) for returning to the reception list screen 19 are displayed on the search screen 18 instead of the “Reception List” transition switch 18d and the “Exam. Start” transition switch 18e. In other words, in the present invention, it is possible to transit to other screens (photographing condition selecting screen, photographing routine screen and the like) only from the initial screen to make an operator be aware of the workflow.

Thus, the transition route among the screens, such as reception list screen, search screen, photographing condition selecting screen, photographing routine screen and the like, is set in accordance with the workflow set beforehand, and only transition switches for making it possible to transmit to a permitted screen are designated on each screen. Thereby, an operator can be made to be aware of the workflow, and input leakage can be prevented. Therefore, rapid and certain photographing and diagnosis can be performed. Further, confusion of processing can be prevented by changing the construction and name of the transition switches in the same screen, in accordance with the workflow. Accordingly, the action of a patient and the action of an operator, such as radiologist or the like, can be matched, so that the operation efficiency can be improved, and an excess burden on a patient according to input leakage or the like can be reduced.

In the image reading apparatus according to the embodiment of the present invention, with respect to the transition among the search screen 18 or the reception list screen 19 for inputting patient information, a photographing condition selecting screen 20 for selecting photographing conditions corresponding to the patient, and the photographing routine screen 21, 22 or 23 of one image view format or package image view format for displaying image data read from a radiographic image converting medium in which a radiographic image of the patient is recorded, the image reading apparatus comprises a section for setting the transition route among the screens in accordance with the workflow set beforehand; and a section for designating transition switches for transiting to a permitted screen on each of a plurality of screens by giving a name capable of recognizing the sequence to the transition switches. An operator is made to be aware of the workflow, and thereby, input leakage of information or the like can be prevented.

As explained above, according to the medical imaging apparatus, the method for transiting display screens in the apparatus, and the screen transition program of the present invention, operationality can be improved, and moreover, input leakage of information can be prevented from occurring by making an operator be aware of a workflow.

This is because the transition route among the reception list screen or the search screen for inputting patient information, the photographing condition selecting screen for inputting photographing conditions, and the photographing routine screen (one image view format or package image view format) for displaying image data in which a patient is photographed is set in accordance with the workflow, and only switches for making it possible to transit to a permitted screen are displayed on each screen, so that an operator can be made to be aware of the workflow. Further, it is because confusion of processing can be prevented by changing the construction and name of transition switches on the same screen.

The entire disclosure of Japanese Patent Application No. 2002-078615 filed on Mar. 20, 2002 including specification, claims, drawings and summary are incorporated herein by reference in its entirety.

What is claimed is:

1. A medical imaging apparatus for displaying a plurality of screens, comprising:
a transition route setting section for setting a transition route among the plurality of the screens in accordance with a workflow set beforehand; and
a transition switch designating section for designating at least one switch for transiting to a screen which is a destination of the set route, on each of the plurality of the screens.

2. The apparatus of claim 1, wherein the apparatus displays at least a patient specifying screen for specifying a patient, a photographing condition selecting screen for selecting a photographing condition corresponding to the patient, and an image data reading screen for displaying image data read from a medical image converting medium in which a medical image of the patient is recorded.

3. The apparatus of claim 1, wherein the setting section includes a section for automatically changing a destination to which a screen transits when the same switch is selected, according to presence or absence of at least one of patient information and photographing condition information.

4. The apparatus of claim 3, wherein in the setting section, in case there is input leakage in essential patient information, a screen is made to transit automatically to a screen for inputting the patient information when an examination start switch, which is a switch designated on one of the plurality of the screens, is selected.

5. The apparatus of claim 2, wherein the setting section includes a section for automatically changing a destination to which a screen transits when the same switch is selected, according to presence or absence of at least one of patient information and photographing condition information, and in the setting section, transition from the patient specifying screen to the photographing condition selecting screen, transition from the photographing condition selecting screen to the image data reading screen, and transition for returning from the image data reading screen to the patient specifying screen are permitted, and in case that the photographing condition information is included in the patient information specified on the patient specifying screen, the patient specifying screen transits directly to the image data reading screen, and in case that the photographing condition information is not included in the patient information, the patient specifying screen transits to the photographing condition selecting screen.

6. The apparatus of claim 5, wherein the patient specifying screen includes a search screen for registering new patient information and searching by using predetermined information as a key, and a reception list screen for displaying a list of the registered patient information; and transition between the search screen and the reception list screen is mutually permitted, and transition only from the patient specifying screen set as an initial screen to the photographing condition selecting screen or the image data reading screen is permitted.

7. The apparatus of claim 2, wherein in the setting section, transition from the patient specifying screen to the photographing condition selecting screen, transition from the photographing condition selecting screen to the image data reading screen, and transition for returning from the image data reading screen to the patient specifying screen are permitted; and in case that information essential to photographing is inputted, transition from the patient specifying screen to the image data reading screen is permitted, and in case that the information essential to photographing is not inputted, transition from the patient specifying screen to the image data reading screen is forbidden.

8. The apparatus of claim 7, wherein the patient specifying screen includes a search screen for registering new patient information and searching by using predetermined information as a key, and a reception list screen for displaying a list of the registered patient information; and transition between the search screen and the reception list screen is mutually permitted, and transition only from the patient specifying screen set as an initial screen to the photographing condition selecting screen is permitted.

9. The apparatus of claim 1, wherein in the designating section, the switch is designated with a name capable of recognizing a state of the workflow.

10. The apparatus of claim 2, wherein the image data reading screen includes a one image view format screen for displaying one image data in a first size and displaying other image data in a size smaller than the first size, and a package image view format screen for displaying a plurality of image data in a second size to be arranged in a line; and transition between the one image view format screen and the package image view format screen is mutually permitted, and transition from either of the one image view format screen and the package image view format screen to the patient specifying screen set as an initial screen is permitted.

11. The apparatus of claim 2, wherein in the workflow such that specifying the patient, selecting the photographing condition, and photographing the patient are performed separately, a transition switch for designating transition to the patient specifying screen is provided on the photographing condition selecting screen, and transition from the photographing condition selecting screen to the patient specifying screen set as an initial screen is performed according to the transition switch.

12. The apparatus of claim 2, wherein a transition switch for designating modifying operation of the specified patient information is provided on the image data reading screen, and transition from the image data reading screen to the patient specifying screen is performed according to the transition switch.

13. The apparatus of claim 2, wherein a transition switch for designating modifying operation of the selected photographing condition is provided on the image data reading screen, and transition from the image data reading screen to the photographing condition selecting screen is performed according to the transition switch.

14. The apparatus of claim 1, wherein in the designating section, the switch provided on each of the screens is designated by a different construction or a different name in accordance with a state of the workflow.

15. A method for transiting a plurality of display screens utilized for diagnosis, comprising:
setting a transition route among the plurality of the screens in accordance with a workflow set beforehand; and
designating at least one switch for transiting to a screen which is a destination of the set route, on each of the plurality of the screens.

16. The method of claim 15, wherein in the designating, the switch is designated with a name capable of recognizing a state of the workflow.

17. A method for transiting display screens including a patient specifying screen for specifying a patient, a photographing condition selecting screen for selecting a photographing condition corresponding to the patient, and an image data reading screen for displaying image data read from a medical image converting medium in which a medical image of the patient is recorded, comprising:
setting a transition route among the plurality of the screens in accordance with a workflow set beforehand; and
designating at least one switch for transiting to a screen which is a destination of the set route, on each of the plurality of the screens with a name capable of recognizing a state of the workflow.

18. The method of claim 17, wherein in the setting, transition from the patient specifying screen to the photographing condition selecting screen, transition from the photographing condition selecting screen to the image data reading screen, and transition for returning from the image data reading screen to the patient specifying screen are permitted; and in case that information essential to photographing is inputted, transition from the patient specifying screen to the image data reading screen is permitted, and in case that the information essential to photographing is not inputted, transition from the patient specifying screen to the image data reading screen is forbidden.

19. The method of claim 18, wherein the patient specifying screen includes a search screen for registering new patient information and searching by using predetermined information as a key, and a reception list screen for displaying a list of the registered patient information; and transition between the search screen and the reception list screen is mutually permitted, and transition only from the patient specifying screen set as an initial screen to the photographing condition selecting screen is permitted.

20. The method of claim 17, wherein the setting includes changing automatically a destination to which a screen transits when the same switch is selected, according to presence or absence of at least one of patient information and photographing condition information, and in the setting, transition from the patient specifying screen to the photographing condition selecting screen, transition from the photographing condition selecting screen to the image data reading screen, and transition for returning from the image data reading screen to the patient specifying screen are permitted, and in case that the photographing condition information is included in the patient information specified on the patient specifying screen, the patient specifying screen transits directly to the image data reading screen, and in case that the photographing condition information is not included in the patient information, the patient specifying screen transits to the photographing condition selecting screen.

21. The method of claim 20, wherein the patient specifying screen includes a search screen for registering new patient information and searching by using predetermined information as a key, and a reception list screen for displaying a list of the registered patient information; and transition between the search screen and the reception list screen is mutually permitted, and transition only from the patient specifying screen set as an initial screen to the photographing condition selecting screen or the image data reading screen is permitted.

22. The method of claim 17, wherein the image data reading screen includes a one image view format screen for displaying one image data in a first size and displaying other image data in a size smaller than the first size, and a package image view format screen for displaying a plurality of image data in a second size to be arranged in a line; and transition between the one image view format screen and the package image view format screen is mutually permitted, and transition from either of the one image view format screen and the package image view format screen to the patient specifying screen set as an initial screen is permitted.

23. The method of claim 17, wherein in the workflow such that specifying the patient, selecting the photographing condition, and photographing the patient are performed separately, a transition switch for designating scheduling operation of the specified patient information and the selected photographing condition information is provided on the photographing condition selecting screen, and transition from the photographing condition selecting screen to the patient specifying screen set as an initial screen is performed according to the transition switch.

24. The method of claim 17, wherein a transition switch for designating modifying operation of the specified patient information is provided on the image data reading screen, and transition from the image data reading screen to the patient specifying screen is performed according to the transition switch.

25. The method of claim 17, wherein a transition switch for designating modifying operation of the selected photographing condition is provided on the image data reading screen, and transition from the image data reading screen to the photographing condition selecting screen is performed according to the transition switch.

26. The method of claim 17, wherein in the designating, the switch provided on each of the screens is designated by a different construction or a different name in accordance with a state of the workflow.

27. A screen transition program for making a computer carry out the method of claim 15.

28. A screen transition program for making a computer carry out the method of claim 17.
